(19) United States
(12) Patent Application Publication
(10) Pub. No.: US 2012/0032929 A1
(43) Pub. Date: Feb. 9, 2012

(54) MODULAR DISPLAY

(76) Inventor: Byoung gu Cho, Seoul (KR)

(21) Appl. No.: 12/851,575

(22) Filed: Aug. 6, 2010

(51) Int. Cl. G09G 5/00; G09G 3/30

(52) U.S. Cl. 345/204; 345/1.3; 345/76

(57) ABSTRACT

In general, embodiments of the present invention provide a modular display created from a plurality of individual displays. The modular display includes control circuitry that diffuses edge lines of the individual displays so that a single, continuous image can be displayed thereon without being obstructed by edge lines. In previous attempts, the edge lines appear in and obstruct the image (e.g., they overlay and/or segment the image in a grid like fashion). Conversely, the edge line diffusion of the present invention render the edge lines invisible wherever the image is displayed. The plurality of individual displays can be pixel-based displays, light emitting diode (LED)-based displays, organic LED (OLED)-based displays, or a combination thereof. Also, the single, continuous image can be 2-dimensional or 3-dimensional. Still yet, the control circuitry is further configured to control the plurality of displays individually and collectively.

### TECHNICAL FIELD

The present invention generally relates to modular displays. Specifically, the present invention relates to a modular display (created from multiple individual displays) that is capable of displaying a single, continuous image without visible edge lines from the individual displays.

### BACKGROUND OF THE INVENTION

As televisions and other displays continue to evolve, the desire for enhanced functionality continues. For example, many computer users now use multiple displays so that different sets of data can be viewed in parallel. In addition, many restaurants and other establishments attempt to increase the size of a display by co-locating several displays in an attempt to create a larger image. Examples of such technology have been developed by CineMassive® and 9 X Media®, Inc. Unfortunately, no previous approach has been successful in co-locating multiple displays without either different images being displayed and/or edge line from the displays appearing in the image in a grid-like or other fashion. Such edge lines cause the image to be segmented or non-continuous in nature, which decreases its quality and its ease of viewing to the user. In view of the foregoing, there exists a need for a solution that solves at least one of the deficiencies in the prior art.

### SUMMARY OF THE INVENTION

In general, embodiments of the present invention provide a modular display created from a plurality of individual displays. The modular display includes control circuitry that diffuses edge lines of the individual displays so that a single, continuous image can be displayed thereon without being obstructed by edge lines. In previous attempts, the edge lines appear in and obstruct the image (e.g., they overlay and/or segment the image in a grid like fashion). Conversely, the edge line diffusion of the present invention render the edge lines invisible wherever the image is displayed. The plurality of individual displays can be pixel-based displays, light emitting diode (LED)-based displays, organic LED (OLED)-based displays, or a combination thereof. Also, the single, continuous image can be 2-dimensional or 3-dimensional. Still yet, the control circuitry is further configured to control the plurality of displays individually and collectively.

A first aspect of the present invention provides a modular display, comprising: a plurality of individual displays combined to create the modular display; and control circuitry configured to adjust circuits within the plurality of individual displays to diffuse edge lines thereof so that a single, continuous image can be displayed across the plurality of individual displays.

A second aspect of the present invention provides a modular display, comprising: a plurality of individual displays combined to create the modular display; and control circuitry configured to adjust circuits within the plurality of individual displays to render edge lines thereof invisible so that a single, continuous image can be displayed across the plurality of individual displays, the control circuitry being further configured to adjust the circuits to alter an aspect ratio of the single, continuous image.

A third aspect of the present invention provides a method for creating a modular display, comprising: combining a plurality of individual displays combined to create the modular display; and diffusing edge lines of the plurality of displays so that a single, continuous image can be displayed across the plurality of individual displays.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a modular display being created by combining individual displays in accordance with an embodiment of the repent invention.

FIG. 2 depicts the modular display of claim 1 after assembly according to an embodiment of the present invention;

FIG. 3 depicts a single, continuous image being displayed on the modular display with a first illustrative aspect ratio according to an embodiment of the present invention.

FIG. 4 depicts a single, continuous image being displayed on the modular display with a second illustrative aspect ratio according to an embodiment of the present invention.

FIG. 5 depicts a single, continuous image being displayed on the modular display with a third illustrative aspect ratio according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, embodiments of the present invention provide a modular display created from a plurality of individual displays. The modular display includes control circuitry that diffuses edge lines of the individual displays so that a single, continuous image can be displayed thereon without being obstructed by edge lines. In previous attempts, the edge lines appear in and obstruct the image (e.g., they overlay and/or segment the image in a grid like fashion). Conversely, the edge line diffusion of the present invention render the edge lines invisible wherever the image is displayed. The plurality of individual displays can be pixel-based displays, light emitting diode (LED)-based displays, organic LED (OLED)-based displays, or a combination thereof. Also, the single, continuous image can be 2-dimensional or 3-dimensional. Still yet, the control circuitry is further configured to control the plurality of displays individually and collectively.

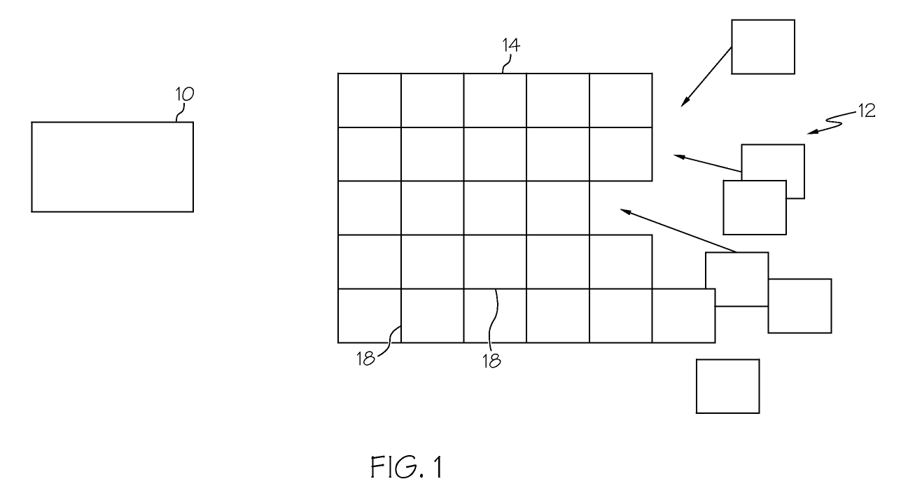

Referring now to FIG. 1, the process by which a modular display 14 is created under embodiments of the present invention is shown. Under the present invention, a plurality of individual displays 12 are combined (e.g., positioned proximate one another to yield a single unit, that is, modular display 14. In general, displays 12 can comprise any type of display now known or later developed. For example, displays 12 can comprise TV panels 10. Along these lines, displays 12 can comprise pixel-based displays, light emitting diode (LED)-based displays, organic LED (OLED)-based displays, or a combination thereof.

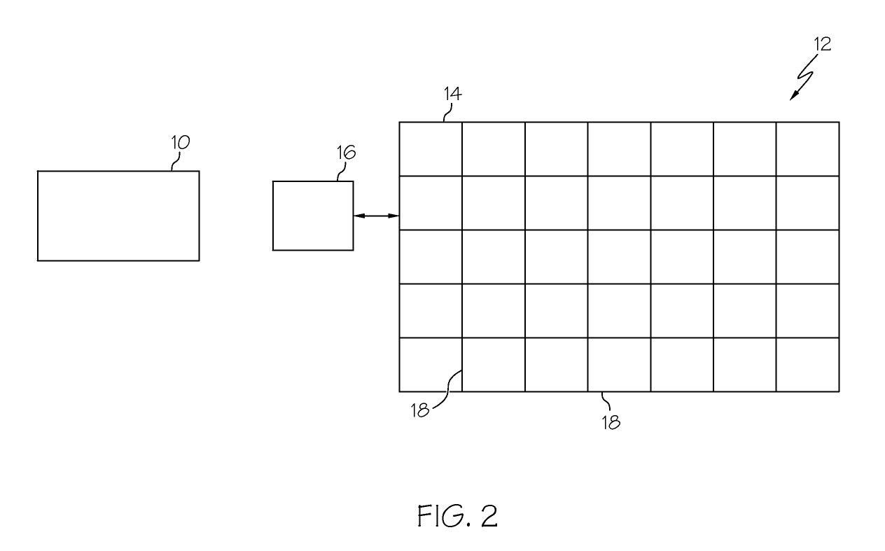

FIG. 2 shows modular display 14 after assembled. Under the present invention, control circuitry 16 is provided to adjust circuits within displays 12 to diffuse edge lines 18 thereof so that a single, continuous image can be displayed across the displays 12. Specifically, control circuitry 16 will render edge lines 18 invisible where the single, continuous image is displayed. In addition, control circuitry 16 is further configured to adjust the circuits to alter an aspect ratio of the single, continuous image while maintaining the invisibility of edge lines 18.

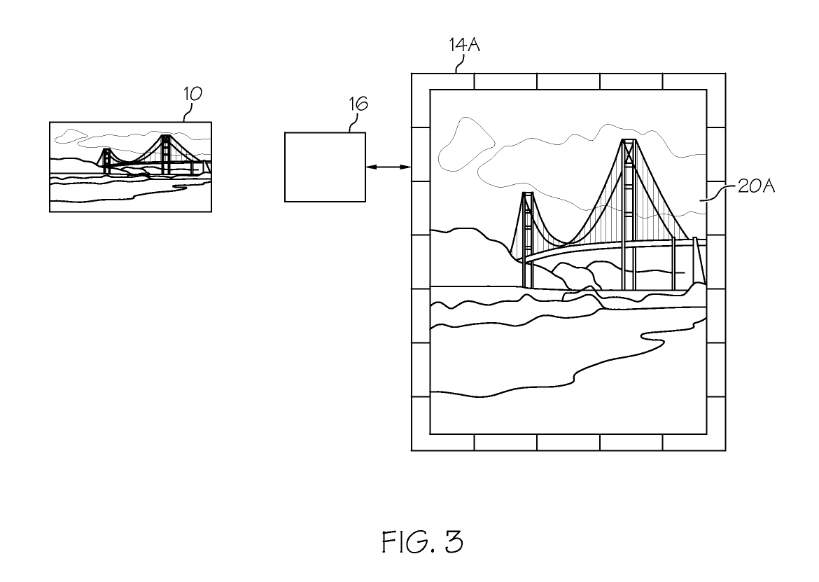

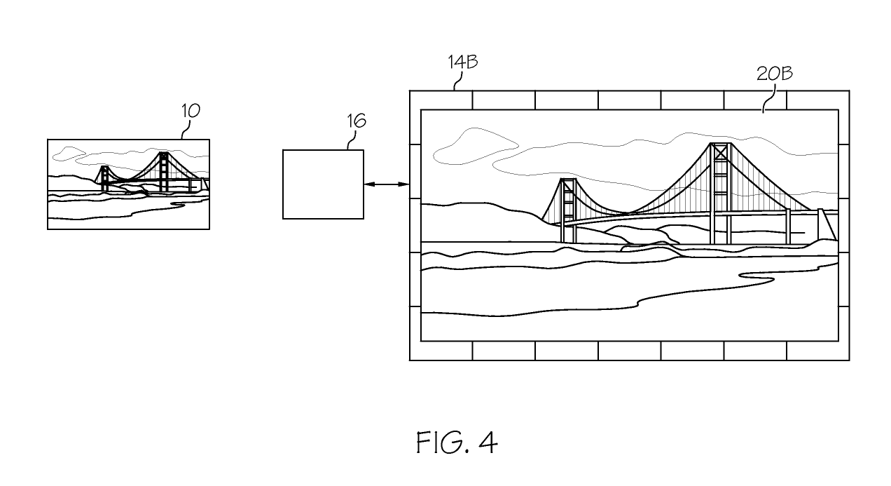

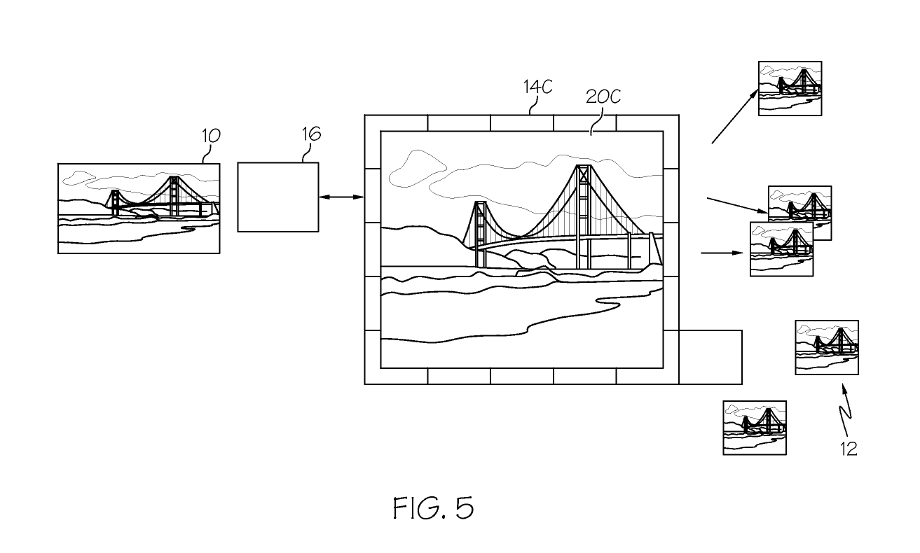

Examples of different aspect ratios are shown in FIGS. 3-5. Specifically, FIG. 3 shows a modular display 14A and image 20A having a first aspect ratio. FIG. 4 shows a modular display 14B and image 20B having a second aspect ratio. FIG. 5 shows a modular display 14C and image 20C having a third aspect ratio. As can be seen, regardless of the aspect ratio, no edge lines are present where images 20A-C appears. This allows images 20A-C to appear as single, continuous images. This is in contrast to previous attempts where edge lines appeared in a grid-like fashion over the image. This resulted in a segmented or non-continuous image. Regardless, it is noted that any images provided on display 14 can be 2-D or 3-D. Moreover, it is understood that in providing its functionality, circuitry 16 can control the displays 12 individually and/or collectively. Still yet, it is understood that additional circuitry (not shown) can be used to control other audio and/or video visual aspects of display, as well as to create 3-D images without the use of assistive devices (e.g., 3-D glasses). This is discussed further in U.S. patent application Ser. No. (to be provided), entitled “3-Dimensional Display and Method of Manufacture”, which is assigned attorney docket number MOON-0008, and was filed on (to be provided), the entire contents of which are herein incorporated by reference.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A modular display, comprising:
a plurality of individual displays combined to create the modular display; and
control circuitry configured to adjust circuits within the plurality of individual displays to diffuse edge lines thereof so that a single, continuous image can be displayed across the plurality of individual displays.

2. The modular display of claim 1, the control circuitry being further configured to adjust the circuits to alter an aspect ratio of the single, continuous image.

3. The modular display of claim 1, the plurality of individual displays being selected from a group consisting of pixel-based displays, light emitting diode (LED)-based displays, organic LED (OLED)-based displays, or a combination thereof.

4. The modular display of claim 1, the single, continuous image being 2-dimensional.

5. The modular display of claim 1, the single, continuous image being 3-dimensional.

6. The modular display of claim 1, the control circuitry being further configured to control the plurality of displays individually and collectively.

7. The modular display of claim 1, the control circuitry rendering the edge lines invisible where the single, continuous image is displayed.

8. A modular display, comprising:
a plurality of individual displays combined to create the modular display; and
control circuitry configured to adjust circuits within the plurality of individual displays to render edge lines thereof invisible so that a single, continuous image can be displayed across the plurality of individual displays, the control circuitry being further configured to adjust the circuits to alter an aspect ratio of the single, continuous image.

9. The modular display of claim 8, the plurality of individual displays being selected from a group consisting of pixel-based displays, light emitting diode (LED)-based displays, organic LED (OLED)-based displays, or a combination thereof.

10. The modular display of claim 8, the single, continuous image being 2-dimensional.

11. The modular display of claim 8, the single, continuous image being 3-dimensional.

12. The modular display of claim 8, the control circuitry being further configured to control the plurality of displays individually and collectively.

13. A method for creating a modular display, comprising:
combining a plurality of individual displays combined to create the modular display; and
diffusing edge lines of the plurality of displays so that a single, continuous image can be displayed across the plurality of individual displays.

14. The method of claim 15, further comprising altering an aspect ratio of the single, continuous image.

15. The method of claim 15, the plurality of individual displays being selected from a group consisting of pixel-based displays, light emitting diode (LED)-based displays, organic LED (OLED)-based displays, or a combination thereof.

16. The method of claim 15, the single, continuous image being 2-dimensional.

17. The method of claim 15, the single, continuous image being 3-dimensional.

18. The method of claim 15, the diffusing comprising rendering the edge lines invisible where the single, continuous image is displayed.
